(19) United States
(12) Patent Application Publication
(10) Pub. No.: US 2009/0256831 A1
(43) Pub. Date: Oct. 15, 2009

(54) Display Apparatus and Circuit Reparation Method Thereof

(75) Inventors: Je-Hao Hsu, Hsinchu (TW); Lee-Hsun Chang, Hsinchu (TW); Wen-Pin Chen, Hsinchu (TW); Chiu Mei Yu, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/190,913

(22) Filed: Aug. 13, 2008

(30) Foreign Application Priority Data
Apr. 11, 2008 (TW) 97113252

(51) Int. Cl. G09G 5/00

(52) U.S. Cl. 345/211

(57) ABSTRACT

A display apparatus and a circuit reparation method thereof are provided. The display apparatus comprises a control module, a first gate on array (GOA) circuit, a second GOA circuit, and a variable voltage source. The control module generates at least one control signal. The first GOA circuit is electrically connected to the control module according to a first leading wire in advance. The second GOA circuit is electrically connected to the control module according to a second leading wire in advance. The variable voltage source provides a predetermined voltage level. When the first GOA circuit is disabled, the first GOA circuit and the control module are adjusted to be electrically disconnected, and the first leading wire is electrically connected to the variable voltage source. The display apparatus is operated in response to the control signal and the predetermined voltage level.

This application claims the benefit of priority based on Taiwan Patent Application No. 097113252 filed on Apr. 11, 2008, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a display apparatus and a circuit reparation method thereof. More specifically, the present invention relates to a display apparatus with at least one gate on array (GOA) circuit and a circuit reparation method for repairing the at least one GOA circuit.

2. Descriptions of the Related Art

Over recent years, flat panel displays have gradually replaced the conventional cathode ray tube (CRT) displays. Currently, flat panel displays primarily fall into the following categories: organic light-emitting diode (OLED) displays, plasma display panels (PDPs), liquid crystal displays (LCDs), and field emission displays (FEDs). Among these flat panel displays, LCDs have become the mainstream in the display market due to their advantages, such as low power consumption, light weight, slim profile and high definition.

A typical LCD has necessary circuits externally connected to a glass substrate thereof for driving, controlling and transmitting data. These circuits are manufactured on a single printed circuit board (PCB), which is then electrically connected to the glass substrate via flexible conductors. To further minimize the volume of an LCD, manufacturers have developed a manufacturing technology known as system-on-glass (SOG); that is, the originally independent drive circuits, control circuits and the like are formed directly onto a glass substrate to save space and reduce the manufacturing cost.

As shown in FIG. 1, a typical LCD 1 incorporating an SOG comprises a display panel 11, a control module 13, a gate on array (GOA) circuit 15 integrating the gate drive circuits onto a glass substrate, and a plurality of scan lines. For purpose of simplicity, only scan lines 101, 103, 105, 107, 109, 111, 113, 115, 117, 119 are illustrated in FIG. 1. The control circuit 13 is configured to send various control signals to the GOA circuit 15 via a plurality of leads, examples of which denoted in FIG. 1 are a ground (Vss) lead 131, a start pulse (ST) lead 133, a positive phase clock (CK) lead 135 and an opposite phase clock (XCK) lead 137. The GOA circuit 15 is configured to control the switching-on or -off operations of individual scan lines 101, 103, . . . , 119 in response to the control signals received via the leads 131, 133, 135, 137. Then, the image is displayed on the display panel 11 through the switching-on or -off operations of the scan lines.

The typical LCD 1 incorporating an SOG described above allows the otherwise independent gate drive circuits to be formed directly on the glass substrate, which helps to remarkably save space and reduce the manufacturing cost otherwise required to manufacture the drive circuits. Unfortunately, if the GOA circuit that integrates the gate driving circuits onto the glass substrate is damaged, the manufacture will have to discard the glass circuit with the damaged GOA circuit because it is difficult to repair. As a result, not only is the manufacturing process difficult, but resources are wasted when the entire GOA circuit is discarded after damage.

In view of this, it is important to find an alternative to discarding the entire GOA circuit when there is damage during the manufacturing of an LCD that integrates gate drive circuits onto the glass substrate.

### SUMMARY OF THE INVENTION

One objective of the present invention is to provide a display apparatus, which comprises a control module, a first GOA circuit, a second GOA circuit and a variable power. The control module is configured to generate at least one control signal. The first GOA circuit is electrically connected to the control module via a first lead to receive the at least one control signal. The second GOA circuit is electrically connected to the control module via a second lead to receive the at least one control signal. The variable power is configured to supply a predetermined voltage level. When the first GOA circuit is disabled, the electrical connection between the first GOA circuit and the control module is adjusted to electrically disconnect. The first lead is electrically connected to the variable power, while the first GOA circuit receives the predetermined voltage level via the first lead. The display apparatus operates in response to the at least one control signal and the predetermined voltage level.

Another objective of the present invention is to provide a circuit reparation method for use in the display apparatus described above. The first lead is electrically connected to the control module and the first GOA circuit, while the second lead is electrically connected to the control module and the second GOA circuit. The circuit reparation method comprises the following steps: cutting off the first lead when the first GOA circuit is disabled; connecting the first lead and the variable power electrically; receiving the predetermined voltage level via the first lead; and receiving the at least one control signal via the second lead.

In conclusion, the display apparatus of the present invention has two GOA circuits disposed therein, both of which receive the same control signal from a control module. If the manufacturer detects that one of the GOA circuits is damaged during the post-production test of the display apparatus, the damaged GOA circuit can be electrically disconnected to the control module and then electrically connected to a predetermined voltage level. In this way, the entire damaged GOA circuit does not need to be discarded. Rather, the damaged GOA circuit is replaced by the other GOA circuit pre-fabricated on the glass substrate, thus easing the difficulty in repairing the GOA circuit as well as reducing the manufacturing cost.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a typically conventional LCD incorporating an SOG;

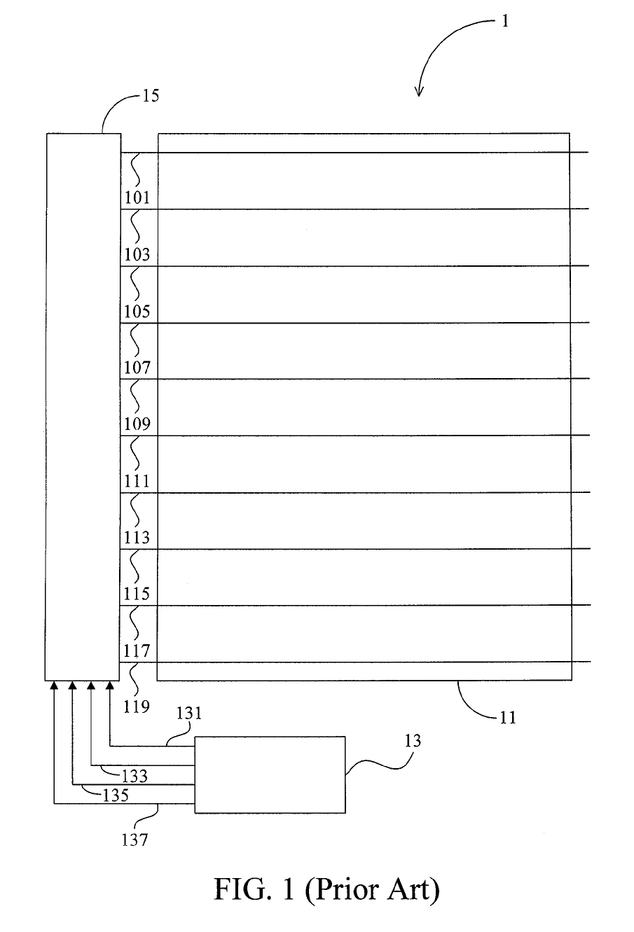

FIG. 2A is a schematic view of a preferred embodiment of the present invention;

FIG. 2B is another schematic view of the preferred embodiment of the present invention; and

FIG. 3 is a flow chart of another preferred embodiment of the present invention.

### DESCRIPTION OF THE PREFERRED EMBODIMENT

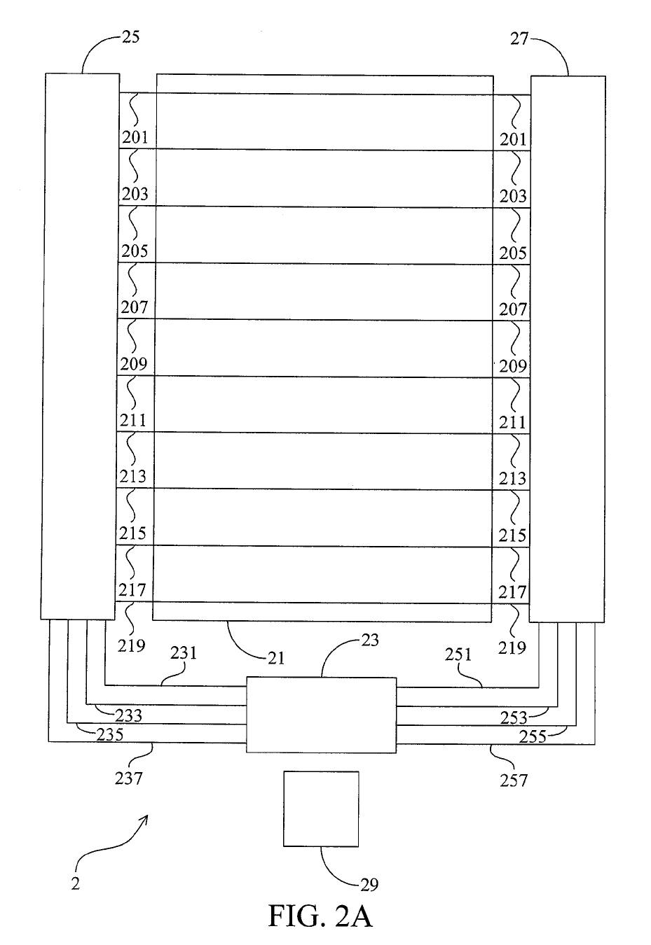

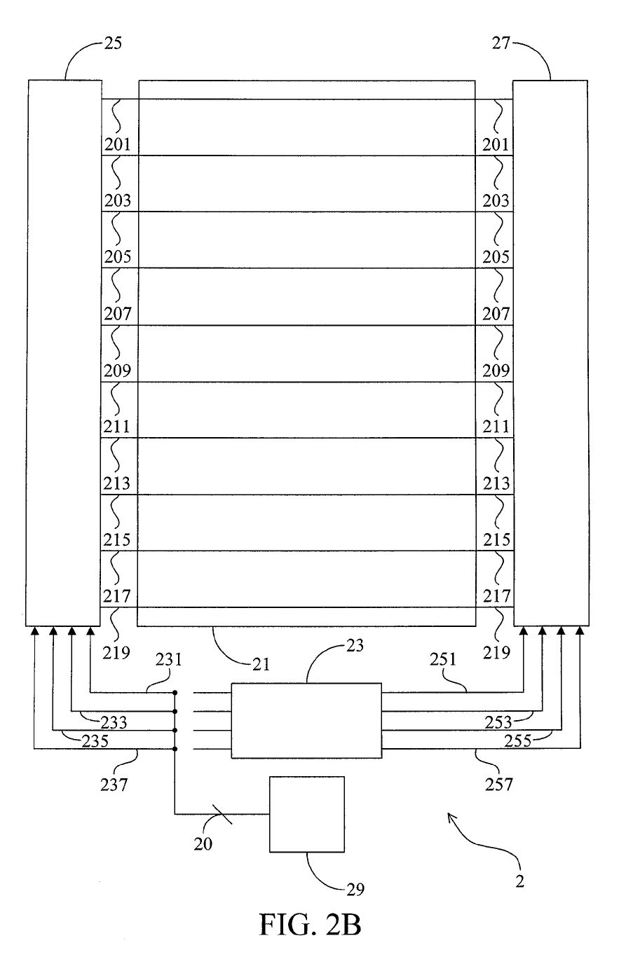

A preferred embodiment of the present invention is illustrated in FIG. 2A, which is a schematic view of a display apparatus 2. The display apparatus 2 may be a wide variety of flat panel displays, such as an organic light-emitting diode (OLED) display, a plasma display panel (PDP), a liquid crystal display (LCD), or a field emission display (FED). The display apparatus 2 comprises a display panel 21, a control module 23, a first GOA circuit 25, a second GOA circuit 27, a variable voltage source 29 and a plurality of scan lines (for simplicity, only scan lines 201, 203, 205, 207, 209, 211, 213, 215, 217, 219 are illustrated in FIG. 2). The first GOA circuit 25 is electrically connected to the control module 23 via a plurality of first leads. The control circuit 23 is configured to send various control signals to the first GOA circuit 25 via the first leads. Also for simplicity, only a first ground (Vss) lead 231, a first start pulse (ST) lead 233, a first positive phase clock (CK) lead 235 and a first opposite phase clock (XCK) lead 237 are exemplarily illustrated in FIG. 2.

The second GOA circuit 27 is pre-fabricated to be electrically connected with the control module 23 via a plurality of second leads. The control circuit 23 is configured to send various control signals to the second GOA circuit 27 via the second leads as well. Also for the purpose of simplicity, only a second ground (Vss) lead 251, a second start pulse (ST) lead 253, a second positive phase clock (CK) lead 255 and a second opposite phase clock (XCK) lead 257 are exemplarily denoted in FIG. 2.

The first GOA circuit 25 and the second GOA circuit 27 cooperate to control the switching-on or -off operations of the individual scan lines 201, 203, . . . , 219 in response to the control signals received via the first leads 231, 233, 235, 237 and the second leads 251, 253, 255, 257. Then, the image display is enabled on the display panel 21 through the switching-on or -off operations of the scan lines.

It should be noted that when both the first GOA circuit 25 and the second GOA circuit 27 in the display apparatus 2 operate normally, they receive the same control signals from the control module 23. All the scan lines 201, 203, . . . , 219 are controlled to be switched on or off by the first GOA circuit 25 and the second GOA circuit 27 respectively.

When either one of the first GOA circuit 25 and the second GOA circuit 27 is detected to be disabled during a test of the display apparatus 2. For example, if the first GOA circuit 25 is damaged, the electrical connection between the first leads 231, 233, 235, 237 and the control module 23 will be adjusted to be electrically disconnected. That is, the electrical connection between the first leads 231, 233, 235, 237 and the control module 23 will be cut off, as shown in FIG. 2B. Furthermore, the first leads 231, 233, 235, 237 are electrically connected to the variable voltage source 29, which is configured to supply a predetermined voltage level 20. Then, the first GOA circuit 25 receives the predetermine voltage level 20 via the first leads 231, 233, 235, 237.

Finally, after the reparation as described in the previous paragraph is completed, the predetermined voltage level 20 sets the first GOA circuit 25 into a stable inactive status, while the control signals received by the second GOA circuit 27 via the second leads 251, 253, 255, 257 continue to control the switching-on or -off operations of the individual scan lines 201, 203, . . . , 219. The image display can still be enabled on the display panel 21 through the switching-on or -off operations of the scan lines.

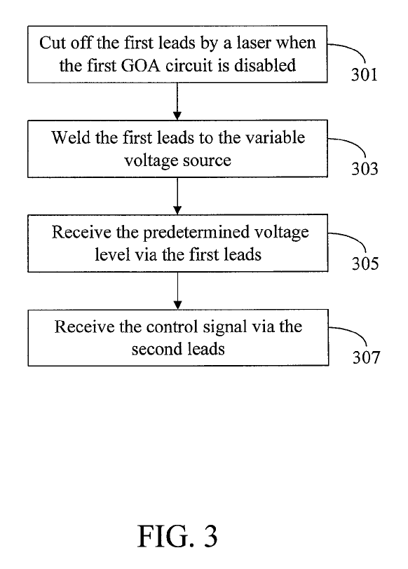

On the other hand, another preferred embodiment of the present invention is illustrated in FIG. 3, which is a flow chart of a circuit reparation method for use in the display apparatus 2 previously described. The process flow of the circuit reparation method will now be described.

Initially, step 301 is executed to cut off the first leads, e.g., the first ground lead 231, the first ST lead 233, the first positive phase clock lead 235 and the first opposite phase clock lead 237, by a laser when the first GOA circuit is disabled. Then, in step 303, the first leads are welded to the variable voltage source to be electrically connected to the variable voltage source. Next in step 305, the predetermined voltage level is received via the first leads. Finally, the control signal is received via the second leads in step 307.

It should be noted that the way to cut off the first leads is not merely limited to use of a laser, and those skilled in the art may use other means to cut off the first leads. Likewise, the way to electrically connect the first leads and the variable voltage source is not merely limited to welding, and those skilled in the art may use other means to accomplish this electrical connection. Thus, these will not be further described herein.

In summary, two GOA circuits have been placed into the display apparatus of the present invention during the manufacturing process. Consequently, if the manufacturer detects that one of the GOA circuits is damaged during the post-production test of the display apparatus, the damaged GOA circuit can be electrically disconnected from the control module and then electrically connected to a variable voltage source to receive a predetermined voltage level. In this way, the glass substrate with the damaged GOA circuit does not have to be discarded altogether; rather, the damaged GOA circuit is replaced by the other GOA circuit pre-fabricated on the glass substrate, thus making it easier to repair the damaged GOA circuit, as well as reducing manufacturing costs.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display apparatus, comprising:
a control module being configured to generate at least one control signal;
a first gate on array (GOA) circuit, being electrically connected to the control module via a first lead to receive the at least one control signal;
a second GOA circuit, being electrically connected to the control module via a second lead to receive the at least one control signal; and
a variable power being configured to supply a predetermined voltage level, wherein when the first GOA circuit is disabled, the electrical connection of the first GOA circuit and the control module is adjusted to electrical disconnection, the first lead is electrically connected to the variable power, the first GOA circuit receives the predetermined voltage level via the first lead, and the display apparatus is operated in response to the at least one control signal and the predetermined voltage level.

2. The display apparatus as claimed in claim 1, wherein the first lead is a ground lead (Vss) and the first GOA circuit receives the predetermined voltage level via the ground lead.

3. The display apparatus as claimed in claim 1, wherein the first lead is a start-pulse (ST) lead and the first GOA circuit receives the predetermined voltage level via the ST lead.

4. The display apparatus as claimed in claim 1, wherein the first lead is a positive phase clock (CK) lead and the first GOA circuit receives the predetermined voltage level via the CK lead.

5. The display apparatus as claimed in claim 1, wherein the first lead is an opposite phase clock (XCK) lead and the first GOA circuit receives the predetermined voltage level via the XCK lead.

6. A circuit reparation method for use in the display apparatus as claimed in claim 1, the first lead being electrically connected to the control module and the first GOA circuit, the second lead being electrically connected to the control module and the second GOA circuit, the circuit reparation method comprising the following steps of:
cutting off the first lead when the first GOA circuit is disabled;
connecting the first lead and the variable power electrically;
receiving the predetermined voltage level via the first lead; and
receiving the at least one control signal via the second lead.

7. The circuit reparation method as claimed in claim 6, wherein the cutting off step further comprises a step of cutting off the first lead by a laser.

8. The circuit reparation method as claimed in claim 6, wherein the connecting step further comprises a step of welding the first lead to the variable power.

9. A display apparatus, comprising:
a control module being configured to generate at least one control signal;
a variable power being configured to supply a predetermined voltage level;
a first GOA circuit, being electrically connected to the variable power via a first lead to receive the predetermined voltage level; and
a second GOA circuit, being electrically connected to the control module via a second lead to receive the at least one control signal, wherein the display apparatus is operated in response to the at least one control signal and the predetermined voltage level.

10. The display apparatus as claimed in claim 9, wherein the first lead is a ground lead, and the first GOA circuit receives the predetermined voltage level via the ground lead.

11. The display apparatus as claimed in claim 9, wherein the first lead is an ST lead and the first GOA circuit receives the predetermined voltage level via the ST lead.

12. The display apparatus as claimed in claim 9, wherein the first lead is a CK lead and the first GOA circuit receives the predetermined voltage level via the CK lead.

13. The display apparatus as claimed in claim 9, wherein the first lead is an XCK lead and the first GOA circuit receives the predetermined voltage level via the XCK lead.
